(19) United States
(12) Patent Application Publication
(10) Pub. No.: US 2006/0161550 A1
(43) Pub. Date: Jul. 20, 2006

(54) System and method for distributing customer relationship management information

(76) Inventors: John Carini, Chatham, NJ (US); Mirko Delgado, Tinton Falls, NJ (US); Erwin E. Crampton III, Merrimack, NH (US); Derik Bracke, Cranford, NJ (US); Matthew Zimmerman, Morris Plains, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/036,112

(22) Filed: Jan. 14, 2005

(51) Int. Cl. G06F 17/30

(52) U.S. Cl. 707/10

(57) ABSTRACT

One or more interface programs are communicatively connected to one or more Host CRM applications and a server application. Each Host CRM application is communicatively connected to its own Host CRM database. The server application is communicatively connected to a computer-accessible memory that stores a master set of CRM information in a master table. The master set of CRM information includes information from the one or more Host CRM databases. The interface programs are configured to detect a change in any of the Host CRM databases by communicating with the Host CRM applications. When an interface program detects a change in a Host CRM database, it transmits a message describing the change to the server application. Upon receipt of the message, the server application updates the master table to reflect the change. The server application also updates CRM information stored on client devices communicatively connected to the server application.

### FIELD OF THE INVENTION

This invention relates to a system and a method for distributing customer relationship management (“CRM”) information. In particular, this invention pertains to distributing CRM information from one or more host CRM applications to one or more client devices.

### BACKGROUND OF THE INVENTION

CRM applications are high-powered programs that assist organizations with facilitating and maintaining relationships with their customers. In particular, CRM applications store and process CRM information, such as customer contact information, profiles, order history, sales contracts, billing information, correspondence history, complaints, issues, etc., which assists organizations with serving their customers. CRM applications, referred to herein as “Host CRM applications,” include Siebel CRM on Demand, iExtensions CRM, Relavis Esales, Microsoft CRM, Itraction by Interface Software, NetLedger, Onyx, Salesplace, SalesLogic, and Salesforce.com. (Siebel CRM on Demand is a registered trademark of Siebel Systems Inc.; Relavis is a registered trademark of the Relavis corporation; Microsoft is a registered trademark of the Microsoft corporation; NetLedger is a registered trademark of NetLedger, Inc.; Salesplace is a registered trademark of Interchange Solutions Inc.; and Salesforce.com is a registered trademark of Salesforce.com, Inc.)

To maximize the usefulness of the CRM information managed by a Host CRM application, the CRM information must be distributed to the employees of an organization. However, conventional distribution schemes are hard-coded to work with only one type of Host CRM application, thereby limiting the number of distribution solutions available to an organization. For example, if an organization uses a particular Host CRM application, the organization may choose only from a set of CRM information distribution schemes available for that particular Host CRM application. Further, if a single organization supports multiple Host CRM applications, the organization must use two different CRM information distribution schemes, thereby increasing system complexity. Accordingly, a need in the art exists for a simple, efficient, and effective way to distribute CRM information in a manner independent of the type of Host CRM application used by an organization and/or the number of Host CRM applications used by an organization.

### SUMMARY OF THE INVENTION

The above problems are addressed and a technical solution is achieved in the art by a system and a method for distributing CRM information. According to an embodiment of the present invention, one or more interface programs are communicatively connected to one or more Host CRM applications and a server application. Each Host CRM application is communicatively connected to its own Host CRM database. The interface program(s) may be communicatively connected to the server application via a Web services application. The server application is communicatively connected to a computer-accessible memory that stores a master set of CRM information in a master table. The master set of CRM information includes information from the one or more Host CRM databases. The CRM information may include at least one of: customer contact information, customer profiles, order histories, sales contracts, a correspondence history, price quotes, call reports, complaints, issues, projects, matters, products, services, campaigns, events, sales opportunities, time and billing documents, and other customer related information.

According to an embodiment of the present invention, the interface program(s) is/are configured to detect a change in any of the Host CRM databases by communicating with the Host CRM applications in a format native to each of the Host CRM applications. When an interface program detects a change in a Host CRM database, it generates a message describing the change in a format compatible with the server application, and transmits the message to the server application. Upon receipt of the message, the server application updates the master table to reflect the change.

According to another embodiment of the present invention, one or more client devices are communicatively connected to the server application, and a client table is stored in a computer-accessible memory communicatively connected to the server application. The client table identifies which of the CRM information in the master table is stored on each client device. The CRM information stored on a client device is stored in a local table in a computer-accessible memory communicatively connected to the client device. When a change is made to the master table, the server application accesses the client table to determine which of the client devices is/are affected by the change. Then, the server application generates and transmits a message describing the change to each affected client device, so that the client device(s) may update its/their own local tables to reflect the change.

Prior to transmitting the message, the server application may store the message in a queue to await transfer to the client device(s). The usage of the queue is useful in situations where a client device is not in constant communication with the server application. For example, if a client device is in a physical location where communication with the server application is not possible, the message stays in the queue until communication with the server application becomes available. Once the message is transmitted, it may be removed from the queue.

According to yet another embodiment of the present invention, a client device detects a change in its local table. Once detected, the client device generates a message describing the change and transmits the message to the server application. The message may be stored in a queue on the client device prior to transmission for the reasons discussed above. The message may include credentials used to identify the client device and/or a user of the client device. Upon receipt of the message, the server application verifies the credentials, if applicable, and updates the master table to reflect the change. If verification of the credentials fails, the server application does not update the master table and may transmit an error message to the relevant client device. Further, the server application may generate and transmit a message describing the change to any Host CRM application affected by the change, so that the Host CRM application(s) may update their Host CRM databases. Additionally, the server application may determine which other client device(s) is/are affected by the change based upon the client table. The server application then may generate and transmit a message describing the change to each affected client device, so that the client device(s) may update their own local tables to reflect the change.

According to still another embodiment of the present invention, a client device may request CRM information not stored in its local table from the server application. The request may be stored in a queue on the client device prior to transmission for the reasons discussed above. The request also may include credentials used to identify the client device and/or a user of the client device. Upon receipt of the request, the server application verifies the credentials, if applicable, and transmits the requested CRM information to the requesting client device. If verification of the credentials fails, the server application may deny the request for additional CRM information.

### BRIEF DESCRIPTION OF THE DRAWINGS

The present invention will be more readily understood from the detailed description of preferred embodiments presented below considered in conjunction with the attached drawings, of which:

FIG. 1 illustrates a system for distributing CRM information, according to an embodiment of the present invention;

FIG. 2 illustrates a method for distributing CRM information from one or more Host CRM applications, according to an embodiment of the present invention; and

FIG. 3 illustrates a method for distributing CRM information from a client device, according to an embodiment of the present invention.

It is to be understood that the attached drawings are for purposes of illustrating the concepts of the invention and may not be to scale.

### DETAILED DESCRIPTION OF THE INVENTION

The present invention utilizes one or more interface programs, which facilitate the efficient distribution of CRM information from one or more Host CRM applications to one or more client devices and vice versa. Each interface program is configured to communicate with a Host CRM application in a format native to the Host CRM application and to translate data received from the Host CRM application into a common format for distribution to employees. In other words, the interface program(s) allow CRM information to be distributed to employees regardless of the type of Host CRM application used and/or the number of Host CRM applications used. Accordingly, the present invention provides a CRM information distribution solution that is available to organizations, regardless of the Host CRM application(s) used by the organizations. Further, the present invention provides a way to distribute CRM information from multiple Host CRM applications in a common format, without having a different distribution scheme for each type of Host CRM application, as is done in conventional schemes. Therefore, system complexity and cost are reduced.

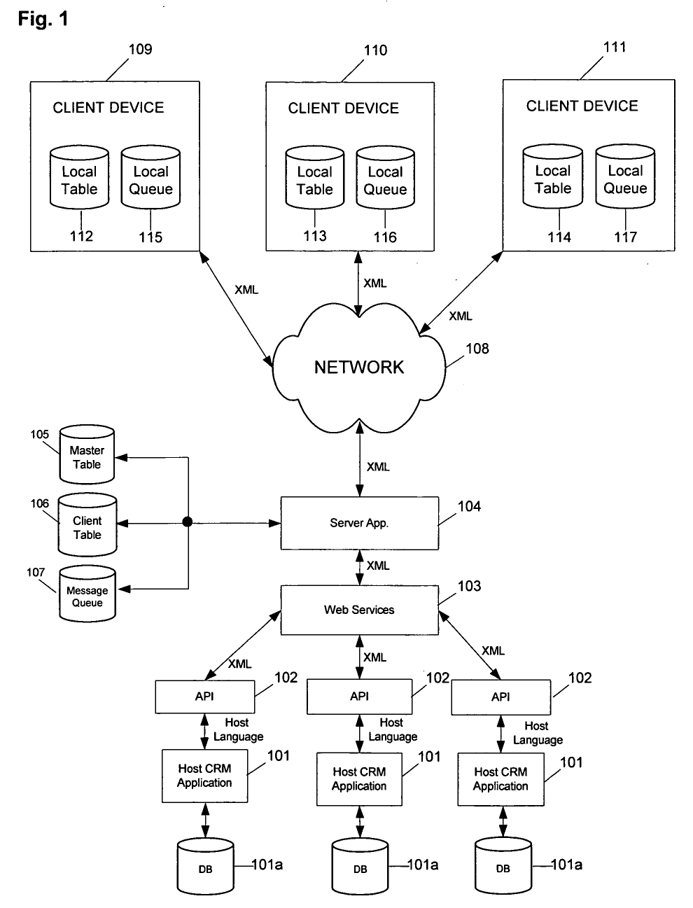

FIG. 1 illustrates a system for distributing CRM information, according to an embodiment of the present invention. One or more Host CRM applications 101 store CRM information in one or more Host CRM databases 101a, respectively. Although the invention is often described with examples illustrating a plurality of Host CRM applications 101, a single Host CRM application 101 and Host CRM database 101a may be used. Further, each Host CRM application 101 may belong to a different customer or entity, or more than one Host CRM application 101 may belong to a single customer or entity.

The CRM information stored in the database(s) 101a, a master table 105 (discussed below) and local tables shown for example with items 112-114 (discussed below) may include at least one of: customer contact information, customer profiles, order histories, sales contracts, a correspondence history, price quotes, call reports, complaints, issues, projects, matters, products, services, campaigns, events, sales opportunities, time and billing documents, and other customer related information. Examples of the CRM information stored in three separate Host CRM databases 101a are shown in Tables I-III, respectively. Although these examples are straightforward for purposes of clarity, one skilled in the art will appreciate that much more data may be stored in the one or more databases 101a.

TABLE I

| First Name | Last Name | Phone Number | Birthday |
|---|---|---|---|
| John | Doe | 555-555-1233 | May 5, 1965 |

TABLE II

| First Name | Last Name | Phone Number | Birthday |
|---|---|---|---|
| Jane | Doe | 555-555-1235 | Sep. 9, 1968 |

TABLE III

| First Name | Last Name | Phone Number | Birthday |
|---|---|---|---|
| Harry | Doe | 555-555-1236 | Mar. 23, 1977 |

Examples of the Host CRM applications 101 include Siebel CRM on Demand, iExtensions CRM, Relavis Esales, Microsoft CRM, Itraction by Interface Software, NetLedger, Onyx, Salesplace, SalesLogic, and Salesforce.com. Each Host CRM application 101 may be executed by one or more computers. Further, more than one Host CRM application 101 may be executed by a single computer. The term “computer” is intended to include any data processing device, such as a desktop computer, a laptop computer, a mainframe computer, a personal digital assistant, a BlackBerry, and/or any other device for processing data, whether implemented with electrical and/or magnetic and/or optical and/or biological components, or otherwise. (BlackBerry is a registered trademark of the Research In Motion Limited corporation).

The Host CRM applications 101 are communicatively connected to one or more interface programs 102, which may be Application Program Interface (“API”) programs. The term “communicatively connected” is intended to include any type of connection, whether wired or wireless, between devices and/or programs in which data may be communicated. Further, the term “communicatively connected” is intended to include a connection between devices and/or programs within a single computer, a connection between computers, or a connection between devices not located in computers at all.

Each Host CRM application 101 may be communicatively connected to a single interface program 102. Optionally, however, a single interface program 102 may be communicatively connected to a plurality of Host CRM applications 101. The interface programs 102 may be executed on the same computer(s) that execute(s) the Host CRM applications 101, or the interface programs may be executed on one or more different computers. Each interface program 102 communicates in a format compatible with its corresponding Host CRM application(s) 101, and translates information received from the corresponding Host CRM application(s) 101 into a format compatible with one or more Web services applications 103 and/or a server application 104. The format compatible with the Web services applications 103 and/or the server application 104 is referred to herein as a “common” format, because, regardless of the format in which a Host CRM application 101 communicates, the interface application(s) 102 generate(s) messages for the Web services applications 103 and/or the server application 104 in the same format. Accordingly, the interface program(s) 102 allow(s) the distribution of CRM information regardless of the type of Host CRM application used and/or the number of Host CRM applications used. According to an embodiment of the present invention, the common format is an XML format, known in the art.

The Web services applications 103 may be communicatively connected to the interface programs 102 and the server application 104. Alternatively, the Web services applications 103 may be omitted, and the interface program(s) 102 may be communicatively connected to the server application 104 directly. The Web services applications 103 perform a forwarding function and route information received from the interface programs 102 to the server application 104. Optionally, the Web services applications 103 translate information received from the interface program(s) 102 into a format compatible with the server application 104. The Web services applications 103 may be executed on the same computer(s) that execute(s) the interface programs 102, or the Web services applications 103 may be executed on one or more different computers. Further, the Web services applications 103 may be executed on the same computer(s) that execute(s) the server application 104. Although the embodiment illustrated with FIG. 1 shows a single server application 104 and Web services application 103 for a plurality of interface programs 102 and Host CRM applications 101, one instance of the server application 104 and, optionally, the web services application 103 may be provided for each interface program 102 and Host CRM application 101.

A master table 105, a client table 106, and a message queue 107 are stored in one or more computer-accessible memories communicatively connected to the server application 104. If more than one instance of the server application 104 is used, a master table 105, a client table 106, and/or a message queue 107 may exist for each instance. Alternatively, if more than on instance of the server application 104 is used, at least two instances of the server application 104 may be communicatively connected to the same master table 105, client table 106, and/or message queue 107. The term “computer-accessible memory” is intended to include any computer-accessible data storage device, whether volatile or nonvolatile, electronic, magnetic, optical, or otherwise, including but not limited to, floppy disks, hard disks, CD-ROMs, DVDs, flash memories, ROMs, and RAMs.

The master table 105 includes CRM information from one or more of the Host CRM databases 101a. The CRM information may include at least one of: customer contact information, customer profiles, order histories, sales contracts, a correspondence history, price quotes, call reports, complaints, issues, projects, matters, products, services, campaigns, events, sales opportunities, time and billing documents, and other customer related information. An example of data stored in the master table 105 is shown in Table IV, which includes information from the databases 101a shown in Tables I-III.

TABLE IV

| Record # | First Name | Last Name | Phone Number |
|---|---|---|---|
| 1 | John | Doe | 555-555-1233 |
| 2 | Jane | Doe | 555-555-1235 |
| 3 | Harry | Doe | 555-555-1236 |

As shown in Table IV, the master table 105 need not include all of the data in the database(s) 101a. In this example, it is determined that the birthday column is not needed in the master table 105 and, consequently, is left out of Table IV. Further, the master table 105 may include additional information not included in the databases 101a, such as a record number field. Although not shown, the master table 105 (or another table) may include information identifying the Host CRM database 101a from which data in the master table 105 originated. For example, Table IV may include information specifying that record number 1 originated from a first Host CRM database 101a, record number 2 originated from a second Host CRM database 101a, and record number 3 originated from a third Host CRM database 101a. However, if only one Host CRM database 101a and corresponding Host CRM application 101 are used, such additional information is not necessary.

An example of data stored in the client table 106 is shown in Table V. Table V indicates that a client device 109 stores a copy of record 1 (John Doe) and record 2 (Jane Doe); a client device 110 stores a copy of record 1 (John Doe); and a client device 111 stores a copy of record 3 (Harry Doe).

TABLE V

| Record # | Client Devices |
|---|---|
| 1 | 109, 110 |
| 2 | 109 |
| 3 | 111 |

Although shown separately, one skilled in the art will appreciate the master table 105 and the client table 106 may be stored in a single table. Further, although the term “table” often is used to describe the format in which data is stored, one skilled in the art will appreciate that the invention is not limited to any particular format for representing data.

The message queue 107 is a message queue used to retain messages to be sent to a client device (109, 110, and/or 111, for example) while communication with the client device is not possible. For instance, if the client device 109 is a BlackBerry, known in the art, that is in a physical location where the server application 104 is unable to communicate with the client device 109, any messages that are to be sent to the client device 109 will be retained in the message queue 107 until communication with the client device 109 resumes.

The server application 104 is communicatively connected to one or more client devices (109, 110, and 111, for example), which may be computers, via a network 108. Client devices 109, 110, and 111 each are communicatively connected to one or more computer-accessible memories storing local CRM information in a local table (112, 113, and 114, respectively) and a local message queue (115, 116, and 117, respectively).

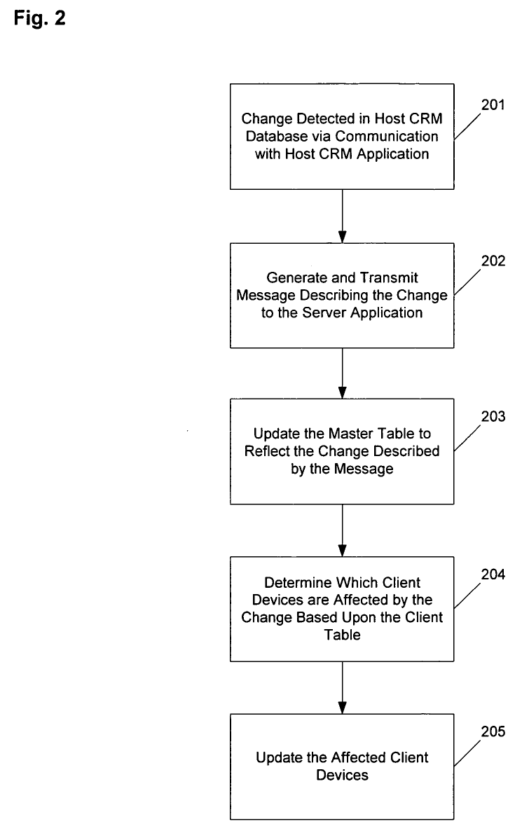

FIG. 2 illustrates a method for distributing CRM information from one or more Host CRM applications 101, according to an embodiment of the present invention. At step 201, a change in the CRM information in at least one of the databases 101a is detected by at least one of the interface programs 102. For example, assume that John Doe's phone number in Table I, which is stored in one of the databases 101a belonging to a Host CRM application 101, is changed to 555-555-1234, as shown in Table VI.

TABLE VI

| First Name | Last Name | Phone Number | Birthday |
|---|---|---|---|
| John | Doe | 555-555-1234 | May 5, 1965 |

At step 201, this change is detected by one or more of the interface programs 102 and is translated into a message having a format compatible with the server application 104, which may be an XML format. For example, an interface program 102 may convert the above-described change into an XML message that specifies that John Doe's phone number has changed to “555-555-1234.” If the change had been to a field not stored in the master table 105, the interface program may be configured to neglect the change. For instance, if the change had been to the birthday field, which is not present in the master table 105 illustrated with Table IV, the interface program may be configured to neglect this change. The interface program 102 transmits the message describing the change to the Web services applications 103 at step 202, which route the message to the server application 104.

Upon receipt of the message, the server application 104 updates the master table 105 to reflect the change, at step 203. For example, the master table 105 illustrated with Table IV is updated as shown in Table VII. If the change had been to a field not stored in the master table 105, the server application 104 may be configured to neglect the change.

TABLE VII

| Record # | First Name | Last Name | Phone Number |
|---|---|---|---|
| 1 | John | Doe | 555-555-1234 |
| 2 | Jane | Doe | 555-555-1235 |
| 3 | Harry | Doe | 555-555-1236 |

After updating the master table 105, the server application 104, at step 204, determines which of the client devices (109, 110, and 111, for example) are affected by the change based upon the client table 106. For example, the client table 106 specifies that the client devices 109, 110 store record number 1. At step 205, a message, which may be in an XML format, is transmitted from the server application 104 to the affected client devices (109 and 110, in this example) informing them of the change. Because the client devices (109 and 110, in this example) may not be in constant communication with the application server, the update messages may be stored in the message queue 107 to await transmission. Once the messages are transmitted, they may be deleted from the message queue 107. Once the client devices (109 and 110, in this example) receive the messages, they update their local tables (112 and 113, respectively, in this example) to reflect the change.

Although FIG. 2 is shown as having a sequential ordering of steps, one skilled in the art will appreciate that the invention is not limited to the particular ordering of steps shown, and that at least some steps may occur in parallel. For example, without limitation, updating of the client devices (steps 204 and 205) does not necessarily have to occur after updating of the master table (step 205), and may occur simultaneously or in reverse order.

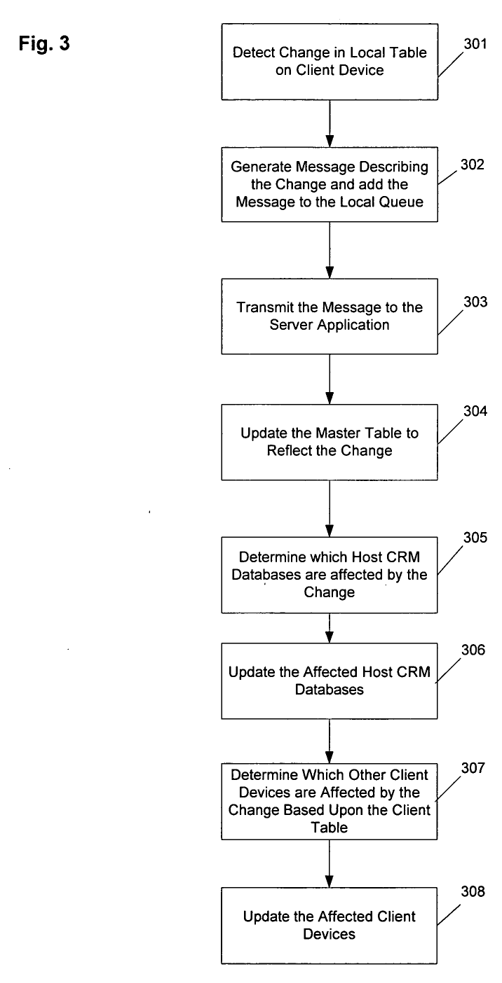

FIG. 3 illustrates a method for distributing CRM information from a client device, according to an embodiment of the present invention. At step 301, a change made to CRM information stored on a client device, such as a change to the local table 112 on the client device 109, is detected by the client device. For instance, assume that the local table 112 appears as shown in Table VIII.

TABLE VIII

| Record # | First Name | Last Name | Phone Number |
|---|---|---|---|
| 1 | John | Doe | 555-555-1234 |
| 2 | Jane | Doe | 555-555-1235 |

Assume that a user of client device 109 changes John Doe's last name in Table VIII to John “Dough.” Once the change is detected, the client device 109 prepares a message, at step 302 describing the change and adds the message to a queue 115, in this example. At step 303, when the client device 109 is capable of communicating with the server 104, the message is transmitted from the client device 109 to the server 104 and removed from the queue 115. Optionally, the message is transmitted with credentials that identify the client device (109, for example) and/or a user of the client device. The credentials may include a user name and a password.

At step 304, if the credentials are validated, the master table 105 is updated to reflect the change identified by the message, as shown in Table IX.

TABLE IX

| Record # | First Name | Last Name | Phone Number |
|---|---|---|---|
| 1 | John | Dough | 555-555-1234 |
| 2 | Jane | Doe | 555-555-1235 |
| 3 | Harry | Doe | 555-555-1236 |

At step 305, it is determined which of the Host CRM databases 101a are affected by the change. This determination may be made based upon information identifying the Host CRM database(s) 101a from which data in the master table 105 originated. For example, the master table 105 may include information specifying that record number 1 originated from a first Host CRM database 101a, that record number 2 originated from a second Host CRM database 101a, and that record number 3 originated from a third Host CRM database 101a. However, if only one Host CRM database 101a and corresponding Host CRM application 101 are used, no determination needs to be made at step 305 because it is known that the one Host CRM database 101a is the only Host CRM database 101a affected.

At step 306, a message describing the change is transmitted from the server application 104 to the Host CRM application(s) 101 associated with the affected Host CRM database(s) 101a. Upon receipt of the message, the Host CRM application(s) 101 update(s) the affected Host CRM database(s) 101a to reflect the change. The message transmitted at step 306 may be transmitted in an XML format to the applicable interface program 102, which converts the message into a format understandable by the pertinent Host CRM application(s) 101.

At step 307, client devices affected by the change, as identified by the client table 106, are identified. At step 308, a message describing the change is generated and transmitted by the server application 104 to the affected client devices, which update their local tables to reflect the change. For example, assume that the client table 106 appears as shown in Table V. Because record number 1 was updated by the client device 109 in this example, a message is sent from the server 104 to the client device 110 instructing it to change John Doe's last name to “Dough.”

Although FIG. 3 is shown as having a sequential ordering of steps, one skilled in the art will appreciate that the invention is not limited to the particular ordering of steps shown, and that at least some steps may occur in parallel. For example, without limitation, updating of the master table (step 304), updating the Host CRM databases 101a (steps 305 and 306), and updating the other client devices (steps 307 and 308) need not occur in the order shown, and may occur simultaneously or another order.

According to an embodiment of the invention, a client device may request CRM information not stored in its local table. In particular, a client device may generate a request for CRM information that is transmitted to the server application 104. For example, assume that the local table 114 of the client device 111 appears as shown in Table X.

TABLE X

| Record # | First Name | Last Name | Phone Number |
|---|---|---|---|
| 3 | Harry | Doe | 555-555-1236 |

In this situation, the client device 111 may generate and transmit a request for record number 1 to the server application 104. The request may include credentials used to verify that the requesting device and/or the requesting user has the authority to view the requested CRM information. If the credentials fail to be verified, the server application 104 may deny the request. If the credentials are verified, the requested record is retrieved from the master table 105 and transmitted to the requesting client device (111 in this example). The client table 106 is updated to identify the new record(s) stored by the requesting client device. For example, the client table 106 illustrated with Table V would be updated as shown in Table XI.

TABLE XI

| Record # | Client Devices |
|---|---|
| 1 | 109, 110, 111 |
| 2 | 109 |
| 3 | 111 |

According to an embodiment of the invention, the systems and methods disclosed herein are embodied, in whole or in part, in computer-executable code stored on one or more computer-accessible memories.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

What is claimed is:

1. A method for distributing contact relationship management (“CRM”) information, the method comprising the steps of:
detecting a change in a host CRM database with an interface program, wherein the interface program communicates with the host CRM application in a format native to the host CRM application, wherein the host CRM database includes CRM information;
transmitting a first message in a common format describing the detected change from the interface program to a processing program, wherein the common format is a format compatible with the processing program; and
updating a master CRM database to reflect the detected change described by the first message, wherein the master CRM database includes CRM information from the CRM information included in the host CRM database.

2. The method of claim 1, further comprising the steps of:
determining which of a plurality of client devices are affected by the detected change; and
transmitting a second message describing the detected change to each of the client devices affected by the detected change.

3. The method of claim 2, wherein at least one of the plurality of client devices is a wireless device.

4. The method of claim 1, wherein the common format is an XML format.

5. The method of claim 1, wherein the CRM information includes at least one of customer contact information, customer profiles, order histories, sales contracts, a correspondence history, price quotes, call reports, complaints, issues, projects, matters, products, services, campaigns, events, sales opportunities, time documents, and billing documents.

6. The method of claim 1, wherein the processing program is a server application.

7. The method of claim 1, wherein the processing program is a Web services application, and wherein the method further comprises the step of transmitting the first message from the Web services application to a server application.

8. The method of claim 1, wherein the host CRM application is Siebel CRM on Demand, extensions CRM, Relavis Esales, Microsoft CRM, Itraction by Interface Software, NetLedger, Onyx, Salesplace, SalesLogic, or Salesforce.com.

9. The method of claim 1, wherein the master CRM database includes CRM information from a plurality of host CRM databases.

10. A method for distributing contact relationship management (“CRM”) information, the method comprising:
detecting a change in a first CRM database communicatively connected to a client device, wherein the first CRM database stores CRM information;
updating a second CRM database storing CRM information based upon the detected change;
determining which, if any, of a plurality of other client devices is/are affected by the detected change; and
transmitting a message describing the detected change to each client device determined to be affected by the detected change.

11. The method of claim 10, wherein at least one client device is a wireless device.

12. The method of claim 10, further comprising the step of transmitting a second message describing the detected change to a host CRM application.

13. The method of claim 10, further comprising the steps of:
determining which of a plurality of host CRM databases are affected by the detected change; and
transmitting a second message describing the detected change to one or more host CRM applications associated with the host CRM databases determined to be affected by the detected change.

14. The method of claim 13, wherein at least one of the one or more host CRM applications is Siebel CRM on Demand, iExtensions CRM, Relavis Esales, Microsoft CRM, Itraction by Interface Software, NetLedger, Onyx, Salesplace, SalesLogic, or Salesforce.com.

15. The method of claim 10, wherein the CRM information includes at least one of customer contact information, customer profiles, order histories, sales contracts, a correspondence history, price quotes, call reports, complaints, issues, projects, matters, products, services, campaigns, events, sales opportunities, time documents, and billing documents.

16. A system for distributing contact relationship management (“CRM”) information, the system comprising:
a host CRM application communicatively connected to a host CRM database that includes CRM information;
an interface program communicatively connected to the host CRM application, wherein the interface program is configured to:
detect a change in the host CRM database by communicating with the host CRM application in a format native to the host CRM application, and generate a first message describing the detected change;
a server application communicatively connected to the interface program, wherein the server application is configured to receive the first message describing the detected change from at least one of the interface programs, and wherein the first message is in a format compatible with the server application; and
a CRM database that includes CRM information from the CRM information included in the host CRM database and that is communicatively connected to the server application, wherein the server application updates the CRM database to reflect the detected change described by the first message.

17. The system of claim 16, further comprising a client device communicatively connected to the server application, wherein the server application transmits a second message to the client device, wherein the second message describes the detected change.

18. The system of claim 17, wherein the client device is a wireless device.

19. The system of claim 16, wherein the CRM information includes at least one of customer contact information, customer profiles, order histories, sales contracts, a correspondence history, price quotes, call reports, complaints, issues, projects, matters, products, services, campaigns, events, sales opportunities, time documents, and billing documents.

20. A computer-accessible memory storing computer code for implementing a method for distributing customer relationship management (“CRM”) information, wherein the computer code comprises:
code for detecting a change in a host CRM database with an interface program, wherein the interface program communicates with the host CRM application in a format native to the host CRM application, wherein the host CRM database includes CRM information;
code for transmitting a first message in a common format describing the detected change from the interface program to a processing program, wherein the common format is a format compatible with the processing program; and
code for updating a master CRM database to reflect the detected change described by the first message, wherein the master CRM database includes CRM information from the CRM information included in the host CRM database.

21. A computer-accessible memory storing computer code for implementing a method for distributing customer relationship management (“CRM”) information, wherein the computer code comprises:
code for detecting a change in a first CRM database communicatively connected to a client device, wherein the first CRM database stores CRM information;
code for updating a second CRM database storing CRM information based upon the detected change;
code for determining which, if any, of a plurality of other client devices is/are affected by the detected change; and
code for transmitting a message describing the detected change to each client device determined to be affected by the detected change.
